(19) United States
(12) Patent Application Publication
(10) Pub. No.: US 2010/0230455 A1
(43) Pub. Date: Sep. 16, 2010

(54) BICYCLE CARRY RACK ASSEMBLY

(76) Inventor: Chiu-Kuei Wang, Taichung County (TW)

Correspondence Address: PHILLIP LIU, 6980, WHITEOAK DRIVE, RICHMOND, BC, V7E 4Z9, CA

(21) Appl. No.: 12/724,231

(22) Filed: Mar. 15, 2010

(30) Foreign Application Priority Data
Mar. 16, 2009 (TW) 098204060
Sep. 23, 2009 (TW) 098217522

(51) Int. Cl. B60R 11/00

(52) U.S. Cl. 224/533

(57) ABSTRACT

A bicycle carry rack assembly includes a connection bar with two adjusting plates selectively connected thereto so as to be connected with different sizes of the connection tube on the vehicles. A U-shaped frame is connected to the connection bar by two boards which have multiple holes and the connection bar can be connected to different holes by pins to set the positions of the support unit on the frame. The frame and the support unit can be pivoted upward or downward relative to the connection bar for achieving different purposes. The support unit includes two rails on which positioning members are connected to support bicycles, a positioning bar is pivotably connected between the two rails and can be set at different angular positions.

### FIELD OF THE INVENTION

The present invention relates to a bicycle carry rack assembly, and more particularly, to a bicycle carry assembly which is adjustably connected to different sizes of the connection tubes on vehicles and the rack can be pivoted to allow the rear door to open.

### BACKGROUND OF THE INVENTION

A conventional bicycle carry rack generally includes a connection bar which has one end connected with the connection tube on the rear end of the vehicle and the other end of the connection bar is connected with the rack on which the bicycles are secured. The sizes of the connection tubes on the rear end of different vehicles may not the same so that when the connection tube is larger or smaller than the connection bar, the bicycle carry rack cannot be securely attached to the vehicles. Once the bicycle carry rack is connected to the vehicle, especially to the vehicle with a rear door, the rear door cannot be operand because the bicycle carry rack is located at the opening way of the rear door. It would be inconvenient to open the rear door by removing the whole bicycle carry rack from the vehicle. Besides, the bicycle carry rack occupies a certain space at the rear end of the vehicle and a longer and larger space is required to park the vehicle with the bicycle carry rack connected thereto. However, the longer and larger parking space is not always available in most of the parking lots.

The present invention intends to provide an improved bicycle carry rack assembly which includes multiple functions and structures to eliminate the problems mentioned above.

### SUMMARY OF THE INVENTION

The present invention relates to a bicycle carry rack assembly which comprises a connection bar has a first end connected with a bicycle carry rack and a second end of the connection bar is selectively connected with multiple adjusting plates. The second end of the connection bar includes two first connection holes and a first pivot hole defined therethrough. Each of the adjusting plates includes two second connection holes and a second pivot hole. The adjusting plates are mounted to outside of second end of the connection bar and bolts extend through the first and second connection holes to connect the adjusting plates to the second end of the connection bar so as to change the size of the second end of the connection bar to be connected with the connection tubes on vehicles of different sizes.

The present invention also provides a bicycle carry rack assembly wherein the bicycle carry rack comprises a frame and a support unit which is connected to the frame, and the support unit includes positioning members which are used to position bicycles thereon. Two boards are fixed to the frame and extend from the frame. Each of the two boards has a first hole and second hole defined therethrough which is located at a distance from the first hole and close to the frame. The first and second holes are located in a first side of each of the boards. A third hole is defined through each of the boards and located close to the frame and a second side of the board. The first end of the connection bar is located between the two boards and a first pin extends through the first holes of the two boards and the connection bar. A second pin extends through the second holes of the two boards and the connection bar. By changing the holes that the second pin extends through, the frame and the support unit can be set at different angular positions relative to the connection bar.

The present invention also provides a bicycle carry rack assembly wherein the bicycle carry rack comprises a frame and a support unit which is connected to the frame. The support unit includes two rails and a positioning bar is connected between the two rails. Each rail has multiple first positioning holes and multiple positioning members are connected to the first positioning holes of the two rails. The positioning members can be installed at different positioning holes of the rails so as to position bicycles of different sizes and shapes.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view to show the bicycle carry rack assembly of the present invention;

FIG. 2 is an exploded view to show the bicycle carry rack assembly of the present invention;

FIG. 3 shows the adjusting plates are mounted to the connection bar to change the size of the second end of the connection bar so as to be connected with the connection tube on vehicles;

FIG. 4 is a cross sectional view to show that the first and second pins connect the connection bar and the tow boards;

FIG. 5 shows that the frame and the support unit of the bicycle carry rack assembly of the present invention are set at a normal position;

FIG. 6 shows that the frame and the support unit of the bicycle carry rack assembly of the present invention arc set at an upright position;

FIG. 7 shows that the frame and the support unit of the bicycle carry rack assembly of the present invention are set at a downward position;

FIG. 8 shows that the positioning bar of the support unit is positioned at different angular positions;

FIG. 9 shows that the positioning bar of the support unit is pivotable relative to the two rails, and

FIG. 10 shows that a bicycle is supported and positioned on the support unit of the bicycle carry rack assembly of the present invention.

### DETAILED DESCRIPTION OF THE PREFERRED EMBODIMENT

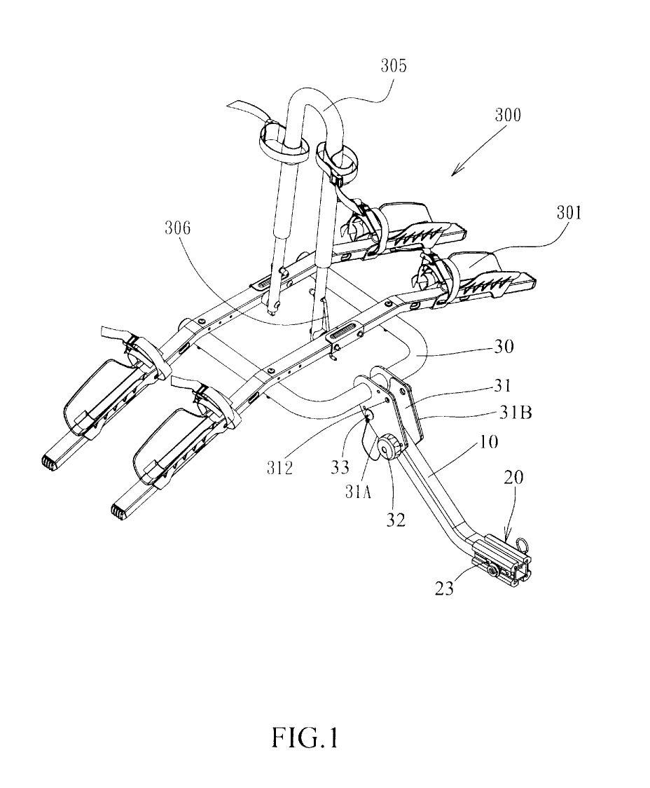

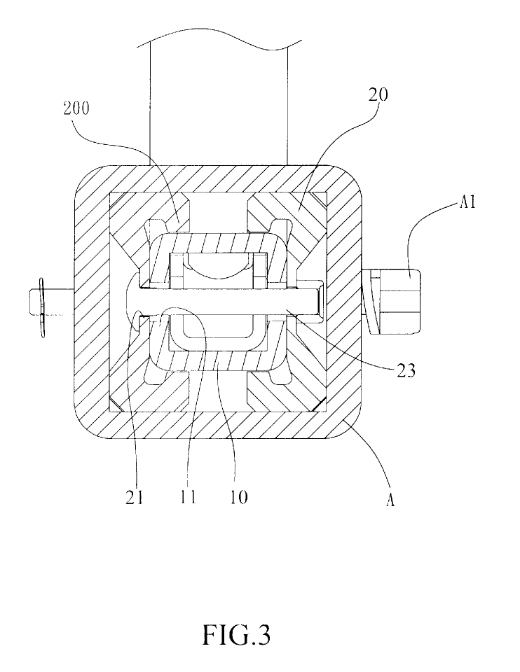

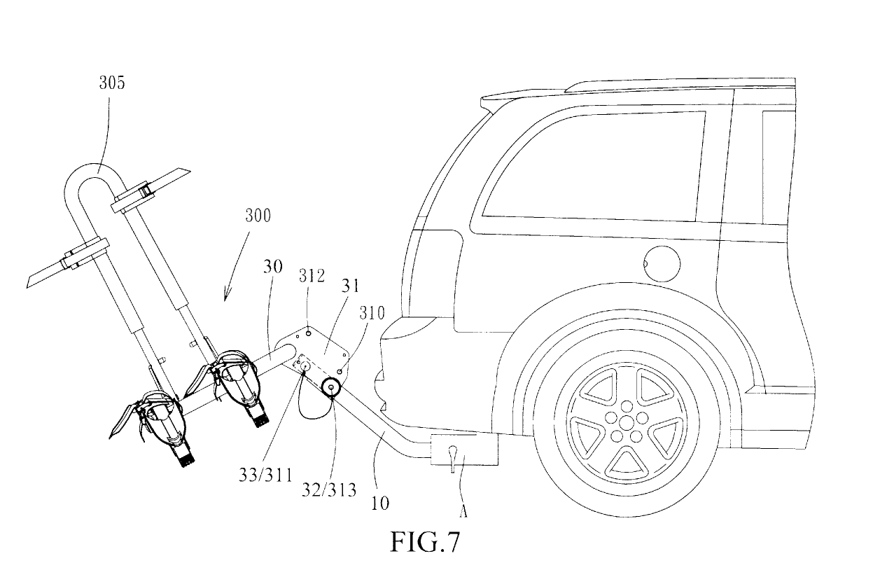

Referring to FIGS. 1, 2, 3 and 7, the bicycle carry rack assembly of the present invention comprises a connection bar 10 having a first end connected with a bicycle carry rack and a second end of the connection bar 10 is connected with the connection tube “A” on the rear end of the vehicle as shown in FIG. 7. The second end of the connection bar 10 is selectively connected with multiple adjusting plates 20, there are two adjusting plates 20 in this embodiment. The second end of the connection bar 10 includes two first connection holes 11 and a first pivot hole 12 defined therethrough. Each of the adjusting plates 20 includes two second connection holes 21 and a second pivot hole 22. The adjusting plates 20 are mounted to outside of second end of the connection bar 10. Each of the adjusting plates 20 includes two side flanges 200 extending from two sides thereof and each side flange 200 is an L-shaped flange whose distal end contacts the outside of the connection bar 10. Bolts 23 extend through the first and second connection holes 11, 21 to connect the adjusting plates 20 to the second end of the connection bar 10. By connecting the two adjusting plates 20 to the second end of the connection bar 10, the size of the second end of the connection bar 10 is increased and can be inserted into the connection tube “A” of larger opening. A pin “A1” is then extended through the connection tube “A”, the second pivot holes 22 of the adjusting plates 20 and the first pivot hole 12 of the second end of the connection bar 10.

When the connection tube “A” is sized to match with the original size of the second end of the connection bar 10, the adjusting plates 20 are removed from the connection bar 10 and the second end of the connection bar 10 can be directly connected to the connection tube “A”. Therefore, by using the adjusting plates 20, the connection bar 10 can be connected with the connection tubes “A” of different sizes.

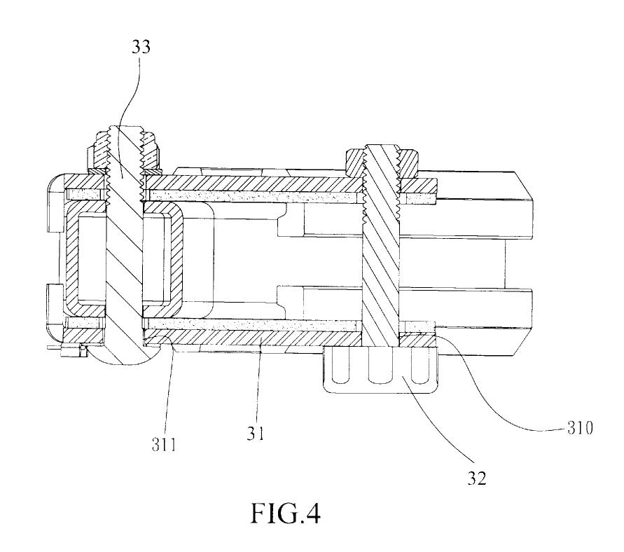

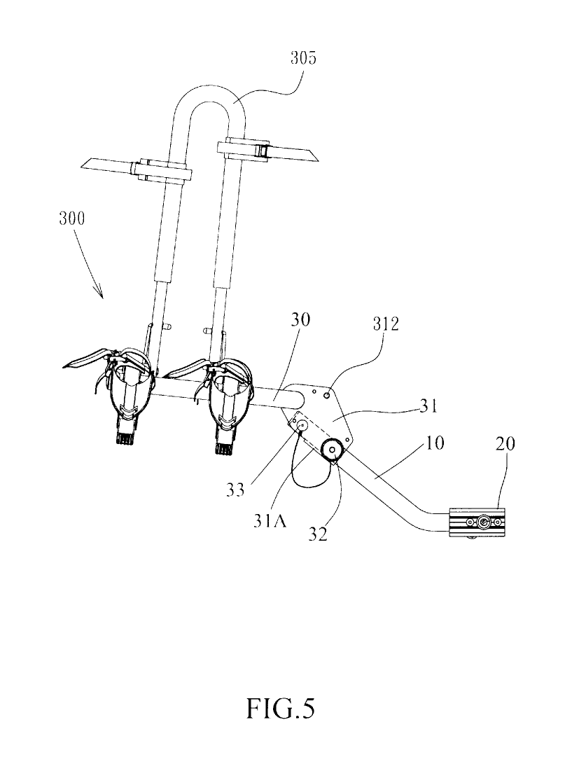

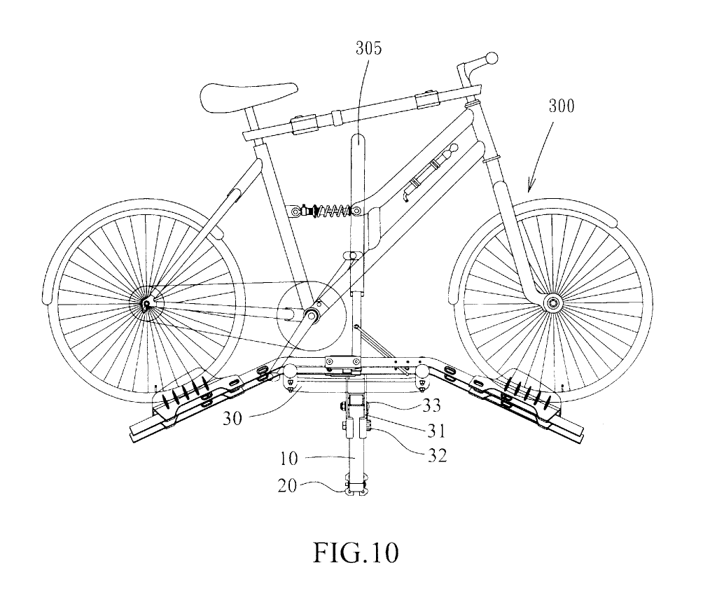

Referring to FIGS. 4 and 5, the bicycle carry rack assembly comprises a U-shaped frame 30 and a support unit 300 which is connected to the frame 30. The support unit 300 includes positioning members 301 to position bicycles thereon as shown in FIG. 10. Two boards 31 are fixed to the frame 30 and extend from the frame 30. Each of the two boards 31 has a first hole 310 and second hole 311 defined therethrough, wherein the second hole 311 is located at a distance from the first hole 310 and close to the frame 30. The first and second holes 310, 311 are located in a first side 31A of each of the hoards 31. A third hole 312 is defined through each of the boards 31 and located close to the frame 30 and a second side 3113 of the board 31.

The first end of the connection bar 10 is located between the two boards 31 and a first pin 32 extends through the first holes 310 of the two boards 31 and the connection bar 10. A second pin 33 extends through the second holes 311 of the two boards 31 and the connection bar 10. By the first and second pins 32, 33, the first end of the connection bar 10 is connected to the two boards 31. A wire is connected between the first and second pins 32, 33 to prevent from loosing any one of the two pins 32, 33 during installation. FIG. 5 shows that the frame 30 and the support unit 300 are located at the normal position which is ready to carry bicycles on the support unit 300.

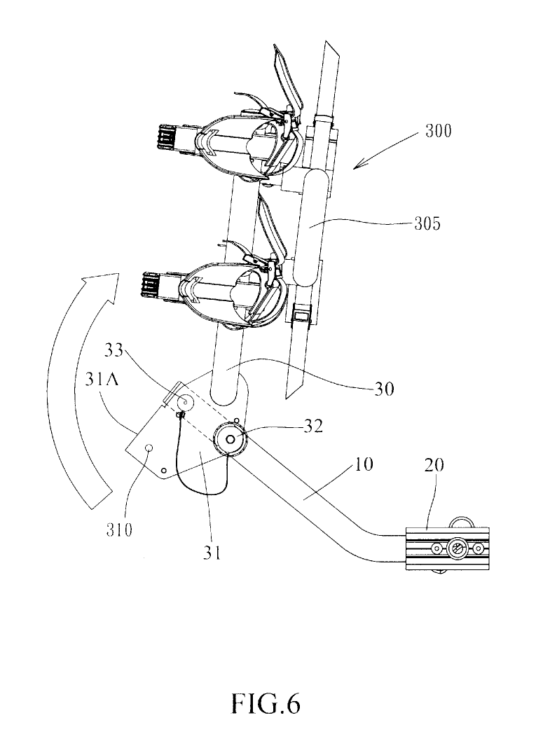

Referring to FIG. 6, when the frame 30 and the support unit 300 are not in use, the first pin 32 is removed from the first holes 310 of the boards 31 and the connection bar 10 such that the frame 30 and the support unit 300 are pivoted upward relative to the connection bar 10. The first pin 32 is then inserted through the third holes 312 and the connection bar 10 to position the frame 30 and the support unit 300 at the upright position. At the upright position, the space required for parking is reduced.

Referring to FIG. 7, each of the boards 31 includes a fourth hole 313 defined therethrough which is located more closer to the first side 31A of the board 31 than the first hole 310. When the rear door of the vehicle is to he opened, the first pin 32 is removed from the first holes 310 of the boards 31 and the connection bar 10 such that the frame 30 and the support unit 300 are pivoted downward relative to the connection bar 10. The first pin 32 is then inserted through the fourth holes 313 and the connection bar 10 to position the frame 30 and the support unit 300 at the downward position. This allows the rear door to be opened while the bicycle carry rack assembly does not need to be disengaged from the vehicle.

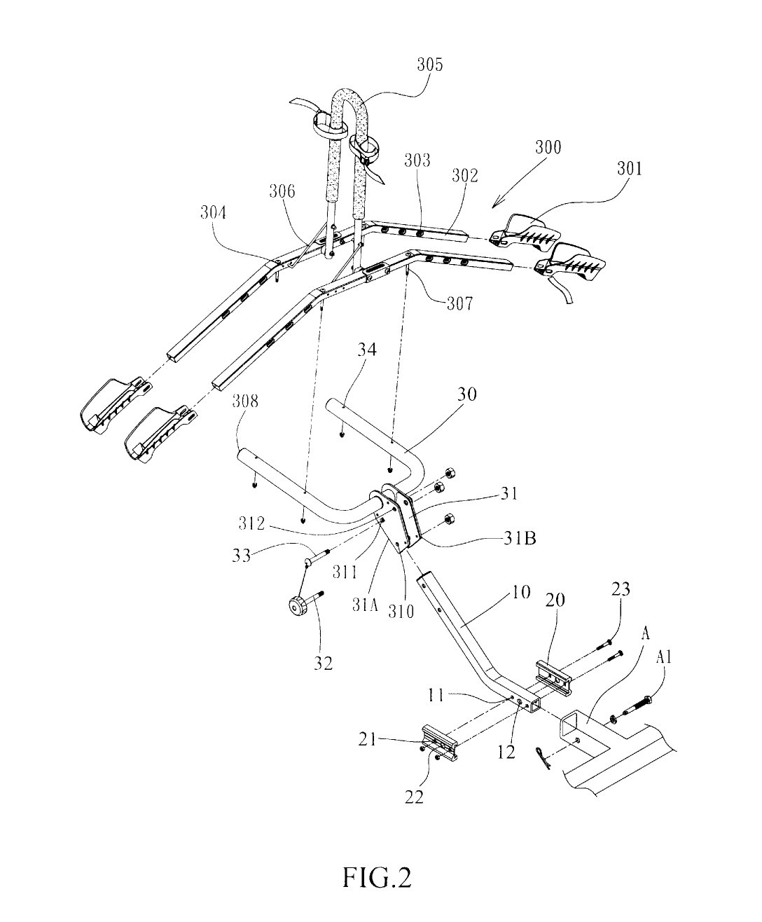

As shown in FIG. 2, the support unit 300 includes two rails 302 and a U-shaped positioning bar 305 is connected between the two rails 302. The frame 30 includes apertures 34 and each of the rails 302 includes insertions 307 extending from an underside thereof, the insertions 307 extend through the apertures 34 and are connected with nuts.

Each rail 302 has multiple first positioning holes 303 and multiple positioning members 301 are connected to the first positioning holes 303 of the two rails 302. By installing the positioning members 301 to the selective first positioning holes 303, the positioning members 301 are located to position bicycles thereon of different shapes and sizes.

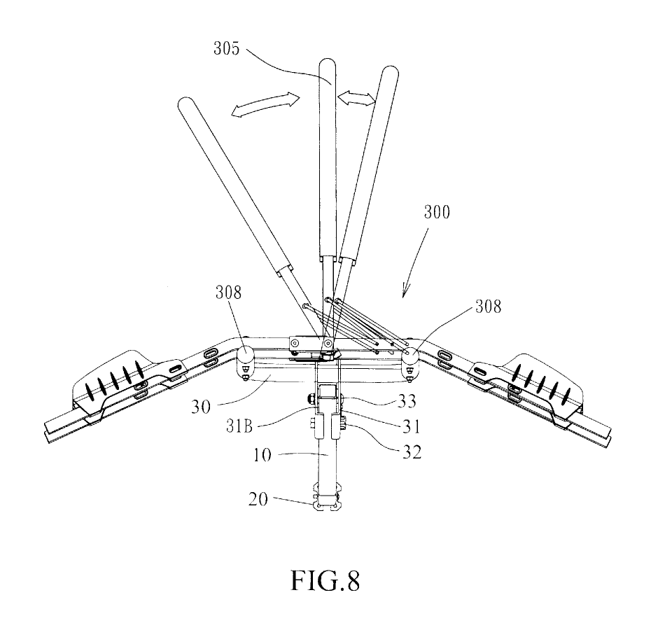

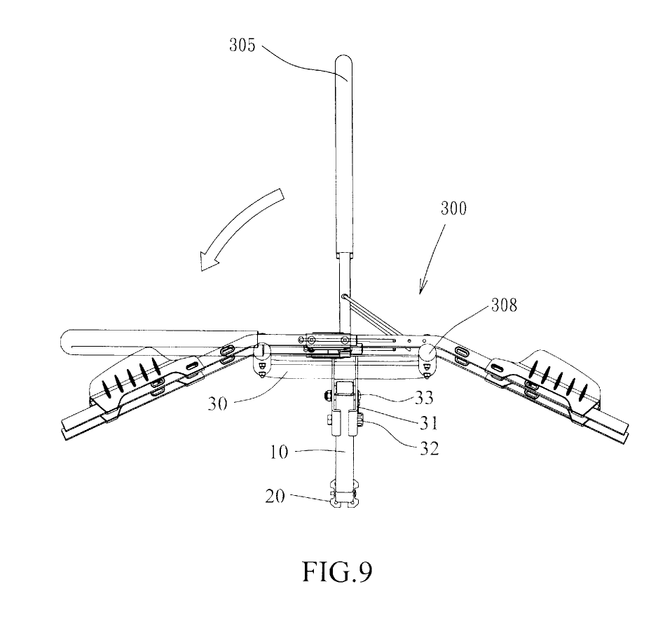

Each of the rails 302 includes multiple second positioning holes 304 defined therethrough and two links 306 each have a first end connected to the positioning bar 305 and a second end of each of the links 306 is connected with one of the second positioning holes 304. The angular positions of the positioning bar 305 can be set by inserting the second ends of the links 306 to different second positioning holes 304 as shown in FIGS. 8 and 9. The positioning bar 305 is used to be connected with the bicycle frame and which is known to persons in the art. For safety concerns, rear lights 308 are installed to the rails 302 as shown in FIG. 8.

While we have shown and described the embodiment in accordance with the present invention, it should be clear to those skilled in the art that further embodiments may be made without departing from the scope of the present invention.

What is claimed is:

1. A bicycle carry rack assembly comprising:
a connection bar (10) having a first end connected with a bicycle carry rack and a second end of the connection bar (10) selectively connected with multiple adjusting plates (20), the second end of the connection bar (10) including two first connection holes (11) and a first pivot hole (12) defined therethrough, each of the adjusting plates (20) including two second connection holes (21) and a second pivot hole (22), the adjusting plates (20) mounted to outside of second end of the connection bar (10), bolts (23) extending through the first and second connection holes (11, 21) to connect the adjusting plates (20) to the second end of the connection bar (10) to change size of the second end of the connection bar (10).

2. The assembly as claimed in claim 1, wherein each of the adjusting plates (20) includes two side flanges (200) extending from two sides thereof and each side flange (200) is an L-shaped flange whose distal end contacts outside of the connection bar (10).

3. A bicycle carry rack assembly comprising:
a connection bar (10) having a first end connected with a bicycle carry rack and a second end of the connection bar (10) adapted to be connected with a connection tube (A) on vehicles, and
the bicycle carry rack comprising a frame (30) and a support unit (300) which is connected to the frame (30), the support unit (300) including positioning members (301) which are adapted to position bicycles thereon, two boards (31) fixed to the frame (30) and extending from the frame (30), each of the two boards (31) having a first hole (310) and second hole (311) defined therethrough which is located at a distance from the first hole (310) and close to the frame (30), the first and second holes (310, 311) located in a first side of each of the boards (31), a third hole (312) defined through each of the boards (31) and located close to the frame (30) and a second side of the board (31), the first end of the connection bar (10) located between the two boards (31) and a first pin (32) extending through the first holes (310) of the two boards (31) and the connection bar (10), a second pin (33) extending through the second holes (311) of the two boards (31) and the connection bar (10).

4. The bicycle carry assembly as claimed in claim 3, wherein the first pin (32) is removed from the first holes (310) of the boards (31) and the connection bar (10) such that the frame (30) and the support unit (300) are pivoted upward relative to the connection bar (10), the first pin (32) is inserted through the third holes (312) and the connection bar (10) to position the frame (30) and the support unit (300) at upright position.

5. The bicycle carry assembly as claimed in claim 3, wherein each of the boards (31) includes a fourth hole (313) defined therethrough which is located more closer to the first side of the hoard (31) than the first hole (310), the first pin (32) is removed from the first holes (310) of the boards (31) and the connection bar (10) such that the frame (30) and the support unit (300) are pivoted downward relative to the connection bar (10), the first pin (32) is inserted through the fourth holes (313) and the connection bar (10) to position the frame (30) and the support unit (300) at downward position.

6. A bicycle carry rack assembly comprising:
a connection bar (10) having a first end connected with a bicycle carry rack and a second end of the connection bar (10) adapted to be connected with a connection tube (A) on vehicles, and
the bicycle carry rack comprising a frame (30) and a support unit (300) which is connected to the frame (30), the support unit (300) including two rails (302) and a positioning bar (305) connected between the two rails (302), each rail (302) having multiple first positioning holes (303) and multiple positioning members (301) connected to the first positioning holes (303) of the two rails (302), the positioning members (301) adapted to position bicycles thereon.

7. The bicycle carry assembly as claimed in claim 6, wherein each of the rails (302) includes multiple second positioning holes (304), at least one link (306) has a first end connected to the positioning bar (305) and a second end of the at least one link (306) is connected with one of the second positioning holes (304).

8. The bicycle carry assembly as claimed in claim 6, wherein the frame (30) includes apertures (34) and each of the rails (302) includes insertions (307) extending from an underside thereof, the insertions (307) extend through the apertures (34) and are connected with nuts.
